(19) United States
(12) Patent Application Publication
(10) Pub. No.: US 2008/0274782 A1
(43) Pub. Date: Nov. 6, 2008

(54) System and Method of Playing a Game Based on the Prediction of the Outcome of Sporting Events

(76) Inventor: Scott Schmidt, New Berlin, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/743,331

(22) Filed: May 2, 2007

(51) Int. Cl. A63F 9/24; A63F 13/12

(52) U.S. Cl. 463/13; 463/42

(57) ABSTRACT

A system and method for playing a game is herein disclosed wherein a listing of teams competing in scheduled events and an additional piece of information is presented to the participants, the predetermined number of teams selected by the participants are received and upon completion of the sporting events, the participants are awarded points according to the scores of the sporting events and the additional information. The points awarded to the participants are utilized in determining a winner for the game.

### FIELD OF THE DISCLOSURE

The present disclosure relates to a system and method of playing a game wherein participants are rewarded for correctly predicting the outcome of scheduled events.

### BACKGROUND

Professional and amateur athletics are a popular past time and diversion for people around the world. Many of the fans of athletic competitions have in the past participated in athletic competitions, but now due to skill and/or age, no longer competitively participate in these sports. Therefore, these fans desire a way to more actively follow the sports that they once competitively played. Furthermore, due to the popularity of sporting events, fans of these sports desire a way to more actively follow the sports in which they have an interest.

One way that people more actively watch sports is by competing against other spectators by picking the winners of selected sporting events. A problem experienced with this system is that there is little variation in the picks to be made, thus resulting in undifferentiated results. The undifferentiated results can lead to frustration among the participants as many participants may have selected the same winning teams, thus resulting in ties between the participants rather than determining a winner. Furthermore, this system is not scalable to be able to involve a large number of participants as the problem of limited differentiation between the results of the participants is only exacerbated as more participants are added to the field. As an example, a sporting league involving 16 teams may engage in 8 head-to-head competitions between the teams each week. If participants select a winner for each of the 8 competitions, there is only 2⁸ or 256 possible combinations of selected outcomes. Therefore, it is highly likely, even if the selections are made randomly, that identical picks will be made by participants.

An alternative way to actively follow sports is to play “fantasy” sports. In “fantasy” sports participants select teams of sports players and manage these teams throughout the season. The participants are awarded points based on the real life performance of the players on the created teams. However, the management of a “fantasy” sports team can be a very involved and time consuming process as the participant must manage the roster of the team and select a lineup on a weekly or sometimes even daily basis. The highly involved management aspect of “fantasy” sports may add interest for some participants, but may act as a barrier for other people to become participants in “fantasy” leagues.

A still further option for those people looking to more actively follow sports is gambling. Gambling has become increasingly popular especially with the recent glamorization of gambling through movies and TV. However, there are many risks that are associated with gambling. Often a wager must be placed on a single game, therefore the risk of the bet is increased because it is based on the performance of a single team. Furthermore, due to the fact that gambling is illegal in many places, a social stigma may attach to someone that is involved in or participates in gambling. Finally, because of gambling's illegality, one may put themselves at risk going to an underground or other less than desirable location to place a bet on a sporting event.

Therefore, a game that allows participants to participate in a competition that reliability determines a winner without requiring a large investment of time is desirable as participants may more actively follow sporting events without devoting an exorbitant amount of time to the game. It is further desirable for the game to be less susceptible to participants achieving the same results even when it is scaled up to a large number of participants. Finally, it is desirable for a game that utilizes gambling concepts in a skill based game, without exposing the participant to the aforementioned risks of gambling.

### BRIEF DISCLOSURE

A system for a participant to play a game is herein disclosed. An embodiment of the system may comprise a computer readable medium storing an executable file that upon execution prompts a display of a listing of teams competing in scheduled events along with a point spread for each of the scheduled events, receives the selection of the predetermined number of teams from the participant and upon completion of the scheduled events awards points to the participant in the amount of the total points scored by each selected team minus the points scored by the opponent of each selected team, the points awarded to the participant being modified in the amount of the point spread for the scheduled event in which the selected team competed.

A further embodiment of a system for engaging a plurality of participants in a game herein disclosed includes a centralized server with a processor and a computer readable medium being programmed with computer executable code, and a plurality of remotely located nodes communitively connected to the centralized server from which a participant may access the centralized server. Upon execution of the computer executable code by the participant, a list of a plurality of competitions between two teams and an additional piece of information may be presented at the node. The centralized server may store a predetermined number of selected teams for each of the plurality of participants and the processor computes a score for each of the participants by awarding points based upon the selected teams, the outcome of the competitions, and the additional piece of information associated with each of the competitions.

A method of playing a game is further herein disclosed. An embodiment of the method may comprise prompting a display of a listing of a plurality of teams competing in scheduled events and a point spread for each of the scheduled events, prompting each participant to select a predetermined number of teams from the listing of teams, receiving a selection of the predetermined number of teams from each participant, and awarding points to each participant upon the completion of the scheduled events. In an embodiment, the points may be awarded to a participant selecting a team that is a favorite in an amount of the total points scored by the selected team minus the point spread for the scheduled event minus the points scored by the opposing team. In a still further embodiment, if the participant selected a team that is an underdog, the participant is awarded points in the amount of the total points scored by the selected team plus the point spread for the scheduled event minus the points scored by the opposing team.

An additional embodiment of a method participating in a game is herein disclosed wherein the game involves a plurality of participants. The method includes viewing a listing of a plurality of competitions between two teams comprising a favorite team and an underdog team, viewing a point spread for the plurality of competitions, selecting a predetermined number of teams competing in the plurality of competitions, upon completion of the competitions, receiving points for each of the selected predetermined number of teams that is a favorite in the amount of the points scored by the favorite minus the point spread minus the points scored by the underdog, and further receiving points for each of the selected predetermined number of teams that is the underdog in the amount the points scored by the underdog plus the point spread minus the points score by the favorite.

### BRIEF DESCRIPTION OF THE DRAWINGS

In the drawings:

FIG. 1 is a schematic diagram of a system for playing a game;

FIG. 2 is a flow chart depicting a method of playing a game;

FIG. 3 depicts an embodiment of a screen shot of a display used in conjunction with embodiments of the system and method;

FIG. 4 depicts a flow chart of an embodiment of the method;

FIG. 5 depicts an embodiment of a screen shot to be presented to a participant in embodiments of the system and method; and

FIG. 6 depicts a screen shot to be presented to a participant in embodiments of the system and method.

### DETAILED DISCLOSURE

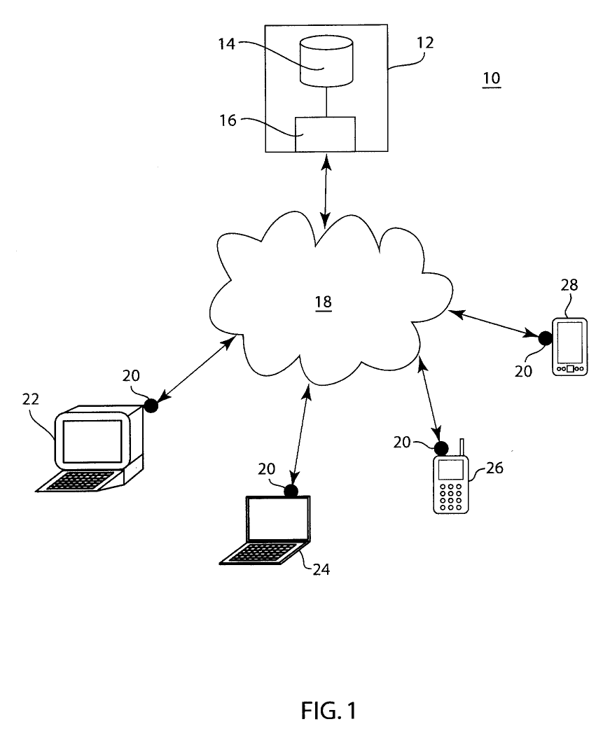

FIG. 1 depicts a schematic diagram of a system 10 that may be utilized for a participant to play a game. The system 10 may comprise a server 12 that comprises a computer readable medium 14 and a processor 16. The computer readable medium 14 stores computer executable code that may be accessed by the processor 16 and executed by the processor 16 to achieve functionality and process according to embodiments of the system and method disclosed herein.

The server 12 and consequently the processor 16 may be connected to an information network 18. The information network 18 may comprise the internet, a local area network (LAN), a wide area network (WAN), or another type of information network that is suitable for use in conjunction with the system and method as disclosed herein. The information network 18 connects to one or more nodes 20 via wired or wireless communication or a combination thereof such that each node 20 is communitively connected to the server 12 and processor 16.

A variety of electronic devices may be connected to the information network 18 at each node 20, any of which are suitable for a participant utilizing the system and method as disclosed herein. The electronic devices connected to a node 20 may comprise a desktop computer 22, a laptop computer 24, a cell phone 26, or a PDA 28; however, this listing is in no way intended to be limiting on the types of electronic devices that may be utilized by a participant to communicate with the processor 16 that executes any executable files stored on computer readable medium 14 of the server 12.

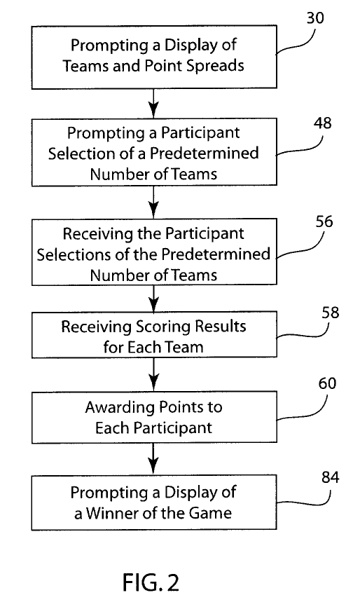

FIG. 2 depicts a flow chart of an embodiment of a method for playing a game. The computer readable medium 14 (FIG. 1) may comprise computer executable code that upon execution by the processor 16 (FIG. 1) performs the steps as depicted in FIG. 2.

At step 30 the execution of the computer executable code prompts a display of a plurality of teams to be engaged in scheduled sporting events and a point spread associated with each of the scheduled sporting events. The sporting events that are displayed may be those sporting events occurring during a specified time period, such as a week, a month or an entire sporting season.

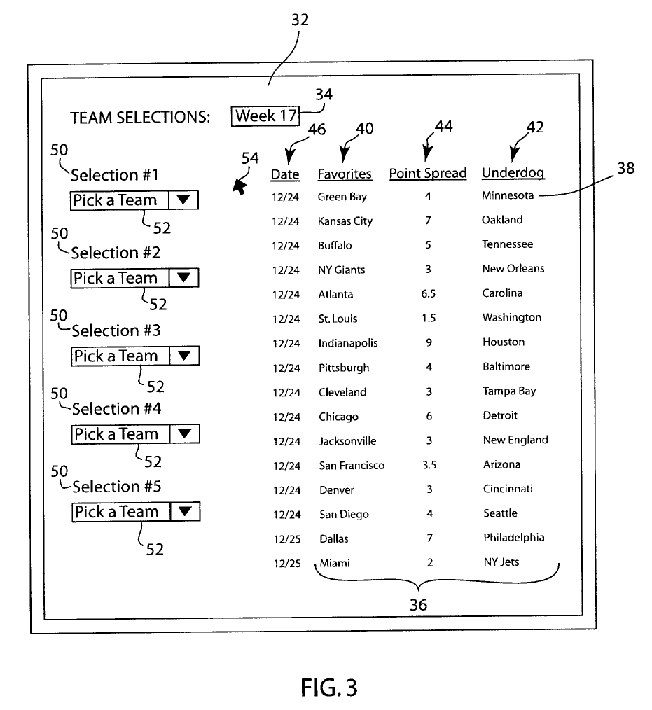

FIG. 3 depicts a screen shot of an embodiment of the prompted display in step 30 of FIG. 2. The display 32 may comprise an indication 34 of the time interval during which the displayed sporting events will be held. The display 32 further comprises a listing 36 of the teams competing in a plurality of sporting events 38. For each of the sporting events 38, one team is listed as the favorite 40 and one of the teams is listed as the underdog 42. Additionally, a point spread 44 is listed with respect to each of the sporting events 38.

The point spread represents a number of points established and/or offered by odds makers to equalize the chances of winning in a wager on a competition between two unevenly matched teams. The point spread represents the number of points by which a stronger team must defeat a weaker team to result in a winning bet on the stronger team. The point spread 44 may be indicated, as depicted in FIG. 3, as a single number between a favorite 40 and an underdog 42. Alternatively, the point spread 44 may be indicated in association with each of the two teams engaged in the sporting event 38 with a positive number representing the underdog 42 and a negative number indicating the favorite 40.

The display 32 may further comprise additional information 46 that is associated with each of the sporting events 38 and may be listed in conjunction with each of the sporting events 38. The additional information 46 may comprise the date upon which the sporting event 38 will take place. Alternative embodiments of the display 32 may include alternative types of additional information 46 which may include the time, location, or weather forecast for each of the sporting events 38. It is understood that many other types of additional information 46 may be listed on the display 32 in conjunction with each of the sporting events 38.

Referring back to FIG. 2, step 48 includes prompting a participant selection of a predetermined number of teams. As depicted in FIG. 3, the display 32 includes a selection prompt 50 for a predetermined number of teams. In the embodiment depicted in FIG. 3, five selection prompts 50 are presented on display 32. It is understood that any number of selection prompts 50 may be utilized within the scope of the system and method as disclosed herein. The selection prompts 50 may comprise a pull-down menu 52 that allows a participant to select a particular team from the listing of teams 36 using a cursor 54 that may be controlled by a mouse, keypad, or other user input device. While a pull-down menu 52 is depicted, many other types of data input interfaces may be utilized including, but not limited to, data fields, radio buttons, or other graphical user interfaces (GUI) associated with the listing of teams 36.

Referring back to FIG. 2, step 56 involves receiving the participant selections of the predetermined number of teams. Once a participant has selected one or more teams, these selections may be sent to the processor 16 which may be in the server 12 via the information network 18 as depicted in FIG. 1. The processor 16 may receive the selections individually as the selections are made, alternatively, all of the selections may be transmitted and received together upon the participant actively choosing to transmit the selections. The participant may actively choose to transmit the selections by interacting with a GUI or other data input or interface associated with, but not depicted in FIG. 3. Upon receiving the participant selections, the processor 16 may store the participant selections in a storage database (not depicted) coupled to the processor 16 or the computer readable medium 14 coupled to the processor 16.

Next, step 58 includes receiving scoring results for each team participating in the sporting events. As depicted in FIG. 1, the processor 16 may be communitively connected to the information network 18. The information network 18 may be connected to alternative sources of data (not depicted) such as other servers or databases. Therefore, the processor 16 may receive data representing the scores achieved by the teams in each of the sporting events. Alternatively, a third party such as a game administrator may enter the scores into the computer readable medium 14 or another similarly situated database (not depicted) that is coupled to the processor 16 such that the processor 16 may receive the scoring results for each team in the sporting events.

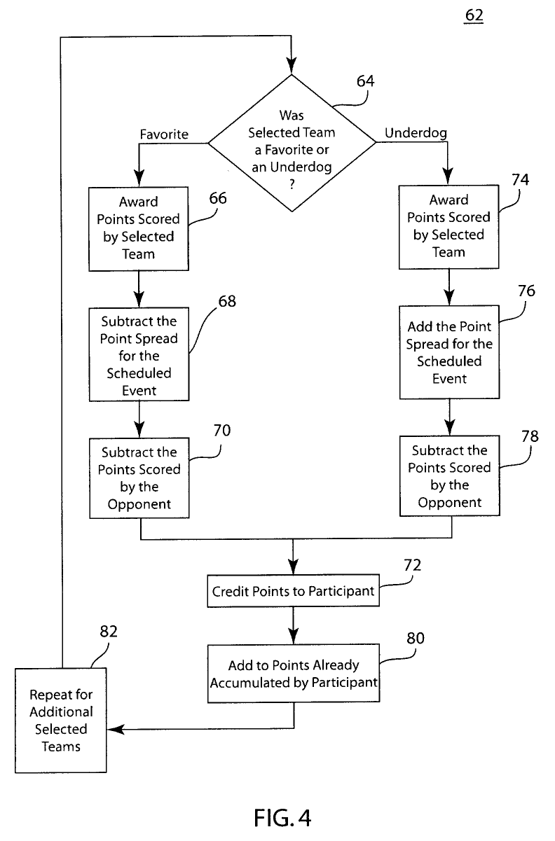

Then, with reference to FIG. 2, step 60 includes awarding points to each participant in the game. FIG. 4 depicts an embodiment of a method or process that may be followed when the processor 16 executes the computer executable code stored on the computer readable medium 14. The embodiment of the method or process represented by the flow chart 62 begins by identifying whether the first team selected by the participant was the favorite or the underdog team at step 64. If the selected team was the favorite for the sporting event, first the participant is awarded points in the amount of the points scored by the selected team at 66. Next, at 68, the point spread for the scheduled event is subtracted from the points awarded at 66. Then, at step 70 the points scored by the selected team's opponent are subtracted from the points resulting from step 68. The total number of points after step 70 is credited to the participant at step 72.

If the team selected by the participant was an underdog for the sporting event, first the participant is awarded points in the amount of the points scored by the selected team at step 74. Next, at step 76, points in the amount of the point spread for the scheduled event in which the selected team competed are added to the points awarded in step 74. Then, at step 78, points in the amount of the points scored by the selected team's opponent are subtracted from the point total resulting from step 76. The total points resulting from step 78 are credited to the participant at step 72.

The points credited to the participant in step 72 may be added at step 80 to any points already accumulated by the participant. Points already accumulated by the participant may be from participation in previous rounds of the game, thus forming an aggregate or total score for the participant for the entire game. Alternatively, the game may be handicapped or otherwise modified by previously awarding points to a participant to which the presently awarded points are added at step 80.

Next, at step 82 the steps depicted in flow chart 62 may be repeated for any additional teams selected by the participant, and repeated for each of the participants in the game. In this manner, each participant is awarded points for the teams selected by that participant during that round or time interval of the game.

As may be appreciated by further inspection of steps 64-80, if a team selected by the participant loses the sporting event, or the favorite team fails to beat the underdog by more than the point spread, it is likely that the points awarded to the participant for the selection of that team will be a negative amount. This is contemplated within the scope of the method and system as disclosed herein as the total points awarded to the participant for the performance of all of the teams selected by the participant may be a positive or a negative number.

In an alternative embodiment, as described with respect to FIG. 3, the point spread 44 may be listed as a pair of numbers with a negative number indicating the team that is a favorite and a positive number indicating the team that is the underdog. In an embodiment such as this, the steps of the method as depicted by flow chart 62 may be modified such that the point spread used in the method is the absolute value of the listed point spreads. Alternatively, step 68 may be modified such that instead of subtracting points in the amount of the positively displayed point spread, negative points in the amount of the negatively displayed point spread are added to the points awarded to the participant.

Referring back to FIG. 2, step 84 includes prompting a display of a winner of the game. The winner of the game may be derived in a variety of ways, an exemplary description of which is included herein. The winner may be determined based upon a single instance or round of the game as described, or alternatively may be determined over a plurality of repetitions or rounds of the game as described that may occur at regular intervals over a period of time. In an example, the rounds may be held at weekly intervals and the total game duration may be over a specified time period, such as an entire season of a sporting event. The winner may be determined as being the participant with the highest total of positive points awarded during a particular round of the game, or the highest total of points awarded over a plurality of rounds of the game. Winners may further be determined as participants that maintain streaks, such as consecutive positive scoring rounds. Furthermore, if a large number of participants are involved, the participants may be divided into sub-groups or divisions. The participants in each sub-group may compete against each other for the determination of a weekly divisional winner, or for spots in a tournament as disclosed herein.

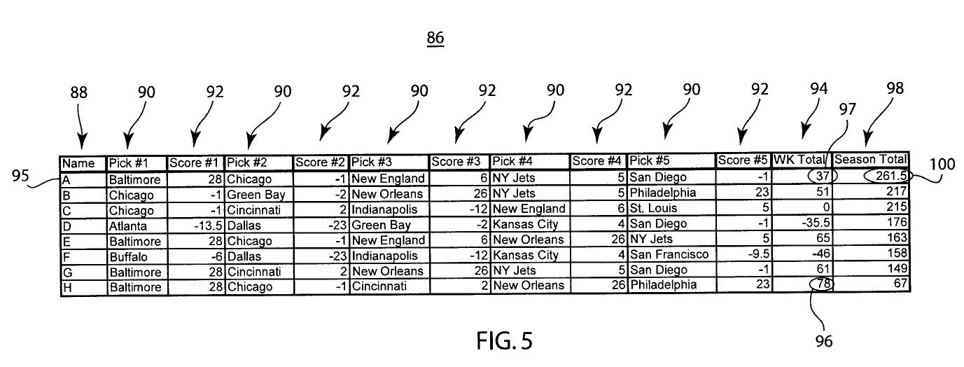

FIG. 5 depicts a chart 86 that may be displayed to display the results of the game, including the winner. The chart 86 includes a listing of the participant's names 88, an indication of each of the teams selected 90 by each of the participants, as well as the points awarded 92 to each of the participants 88 for each of the selected teams 90. The total points awarded for the round of the game 94, such as for a week, may be listed such that the highest score for the week 96 may be identified. Additionally, if the game is played over a plurality of rounds, such as for an entire season of a sporting event, a total for the entire game 98 may be listed such that the winner for the entire game or season 100 may be identified.

Utilizing FIG. 5 with reference to FIG. 3 an example of the computation of the score for participant A 95 is herein disclosed. Participant A's first pick was Baltimore who, according to FIG. 3 was a 4 point underdog against Pittsburgh. After winning the game by 24 points, A is awarded the 24 points plus the 4 points of the points spread for a total of 28 points. Next, A selected Chicago who was a 6 point favorite against Detroit. While Chicago beat Detroit, it was only by 5 points and when the point spread is subtracted from the score, A was awarded −1 points. As a third pick A selected New England who was a 3 point underdog against Jacksonville. New England won the game by 3 points and A was awarded the additional 3 points of the point spread for selecting the underdog team in that competition. Next, A selected the New York Jets who were a 2 point underdog against Miami but also beat Miami by 3 points. Therefore, A was awarded 5 points for the selection of the New York Jets. Finally, A selected San Diego who was a 4 point favorite at Seattle. Since San Diego failed to cover the point spread, A was awarded −1 points.

Participant A's weekly point total 94 is calculated by adding the points awarded for each of the five picks made by participant A. The resulting total is 37 points awarded to participant A as indicated by reference numeral 97. Participant A's 37 points awarded for the round of the competition displayed in FIG. 5 is added to previous points awarded to participant A throughout the rest of the competition, resulting in a competition or season total of 261.5 points. As stated above, this total score was sufficient for participant A to win the competition as indicated by reference numeral 100.

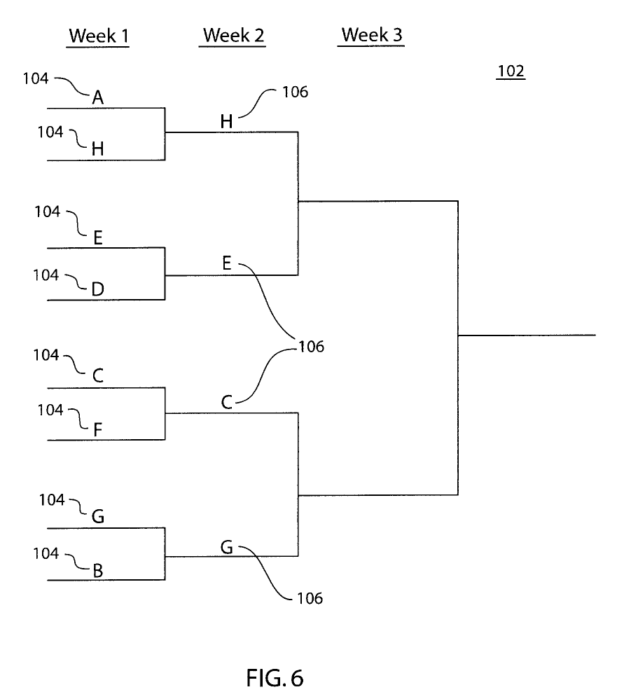

FIG. 6 depicts an alternative embodiment of a display of the winners of the game. FIG. 6 depicts a tournament bracket 102 that places the participants into a tournament that may take place over a series of rounds of the game. Each of the participants 104 may be seeded according to past performance in similar games and/or current performance during an on-going game. Alternatively, if the participants are divided into sub-groups, the tournament may comprise the winners of the sub-group competitions. Each round of the tournament as identified by the bracket 102 may be determined by a round of the game. In the bracket 102 three rounds of the game are required to determine a winner of the tournament by single elimination Each of the participants are matched up in a head-to-head competition with another participant according to the bracket 102. During that specific round of the tournament the participant in each of the head-to-head matches with the higher positive total points advances to the next round of the tournament to compete against other advancing participants 106 as determined by the bracket 102.

As depicted in FIG. 6 with respect to the points awarded to each of the participants for the round depicted in the chart 86 of FIG. 5, participant A and participant H compete head-to-head in the first round of the bracket 102. Participant A was awarded 37 while participant H was awarded 78 points, therefore participant H advances to the next round to face participant E who was similarly awarded more points (65) then were awarded to participant D (−35.5). The game will progress for three rounds until 7 of the participants have been eliminated by single elimination and one participant is named the winner of the tournament 102.

While embodiments have been used to herein disclose a system and method for playing a game, these embodiments are not intended to be limiting on the scope of the embodiments contemplated by the present disclosure. Alternative embodiments of the system and method herein disclosed may comprise limiting the participants to make selections for sporting events for a single type of sport. While National Football League contests have been utilized in this disclosure many other professional and/or amateur leagues and/or sports may be utilized with embodiments of the system and method disclosed herein. These leagues and/or sports may include but are not limited to: Major League Baseball, the National Hockey League, the National Basketball Association, Major League Soccer, Arena League Football, minor league baseball, English Premier League soccer, or any other competitive competition including college and/or high school athletics. Additionally, embodiments of the system and method may be used with individual competitions such as tennis, NASCAR, Professional Bowling Association, or the Olympics.

As herein disclosed, the game may take place as a single round, as a plurality of rounds, or as a plurality of rounds defining the rounds of a tournament. Alternatively, a game may comprise a plurality of rounds resulting in a winner defined by the total aggregate points awarded over the course of the game, while a winner is determined for each round denoting the participant awarded the most points in that particular round. Additionally, during a game consisting of a plurality of rounds, one or more tournaments may be also played throughout the game resulting in the additional determination of tournament winners throughout the game.

In a still further embodiment participants may be allowed to select teams from sporting events from a diverse number of types of sports. Therefore, in a given round, a participant may select for example a football team, a hockey team and a basketball team in any combination. Alternatively, each participant may be required to pick at least one team from each of a list of identified sports. In a still further embodiment, the game may last for the duration of multiple sport seasons such that the participants compete during a year's worth of sporting events across, for example, the football, baseball, and basketball seasons wherein a winner may be determined for each sport and the entire game of sporting event predictions.

In further embodiments of the system and method disclosed herein, the point spreads may be defined by an external third party such as an odds making service and each of the participants may or may not be notified of the involvement of the particular odds making service. Alternatively, the point spreads may be defined and/or derived by a game administrator that manages the operation of the game to ensure a properly run game that is enjoyable for the participants.

Embodiments of the system and method may include modifications by one skilled in the art such as to conform the operation and implementation of the system and/or method with local gaming and/or gambling laws. As such, embodiments of the system and method may be implemented as a skill based game for a competition between a plurality of sports fans. Alternatively, embodiments of the system and method disclosed herein may be implemented in conjunction with gambling in locations wherein these activities are legal.

A further embodiment of the system and method disclosed herein involves the payment of a fee from each of the participants and the collection of these fees by the game administrator in order for the participant to participate in the game. In this embodiment, the winners as determined during the course of the game may be awarded a cash or cash equivalent prize for being a winner. The cash equivalent prizes may include rewards points and/or coupons for merchandise to be redeemed at specified locations.

This written description uses examples to disclose features of the embodiments, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various alternatives and embodiments are contemplated as being the scope of the following claims, particularly pointing out and distinctly claiming the subject matter regarded as the invention.

What is claimed is:

1. A method of playing a game having a plurality of participants, the method comprising:
prompting a display of a listing of a plurality of teams competing in scheduled events between at least one team and at least one opposing team along with a point spread for each of the scheduled events;
prompting each participant to select a predetermined number of the teams from the listing of teams competing in the scheduled events;
receiving a selection of the predetermined number of teams from each participant; and
awarding points to each participant, upon completion of the scheduled events, wherein if a selected team is a favorite in the scheduled event, a participant is awarded points in the amount of the total points scored by the selected team minus the point spread for the scheduled event minus the points scored by the opposing team and wherein if a selected team is an underdog in the scheduled event, the participant is awarded points in the amount of the total points scored by the selected team plus the point spread for the scheduled event minus the points scored by the opposing team.

2. The method of claim 1 further comprising determining a winner based upon the participant with the highest number of points at the end of the game.

3. The method of claim 2 further comprising repeating the method at regular intervals for a predetermined time period.

4. The method of claim 3 further comprising aggregating the points awarded to each participant at each of the repetitions of the method to determine a total score for each of the participants.

5. The method of claim 3 further comprising arranging the participants in a tournament competition, the outcome of each round of the tournament being determined based upon a repetition of the method.

6. The method of claim 3 wherein the predetermined time period is a season of a designated sporting event.

7. A system for a participant to play a game, the system comprising:
a computer readable medium storing an executable file that upon execution:
prompts a display of a listing of teams competing in scheduled events along with a point spread for each of the scheduled events;
prompts the participant to select a predetermined number of teams from the listing of teams competing in scheduled events;
receives the selection of the predetermined number of teams from the participant; and
awards points to the participant, upon completion of the scheduled events, in the amount of the total points scored by each selected team minus the points scored by the opponents of each selected team, the points awarded to the participant being modified in the amount of the point spread for the scheduled event in which the selected team competed; and
a processor coupled to the computer readable medium, the processor executing the executable file stored on the computer readable medium.

8. The system of claim 7 wherein the listing of the teams competing in scheduled events identifies one team for each of the scheduled events as the favorite and identifies one team for each of the scheduled events as the underdog.

9. The system of claim 8 wherein if the participant selects a team identified as a favorite, upon completion of the scheduled event, points in the amount of the point spread are subtracted from the points awarded to the participant.

10. The system of claim 8 wherein if the participant selects a team identified as an underdog, upon completion of the scheduled event, points in the amount of the point spread are added to the points awarded to the participant.

11. The system of claim 7 further comprising a communication device coupled to the processor wherein the processor receives information related to the executable file from an external source via the communication device.

12. The system of claim 11 wherein the processor receives scheduled event data and point spread data from the communication device upon execution of the executable file.

13. The system of claim 12 wherein the processor receives scheduled event result data from the communication device upon completion of the scheduled events.

14. A system for engaging a plurality of participants in a game, the system comprising:
a centralized server comprising a processor and a computer readable medium being programmed with computer executable code; and
a plurality of remotely located nodes from which a participant of the plurality of participants may access the centralized server;
wherein the execution of the computer executable code by the participant at a node prompts a list of a plurality of competitions between two teams to be presented at the node, the executable code further prompts the presentation at the node of an additional piece of information associated with each of the competitions of the plurality of competitions, the centralized server stores a predetermined number of selected teams for each of the plurality of participants, the executable code prompts the processor to compute a score for each of the participants by awarding points based upon the selected teams for each of the participants, outcome of the competitions, and the additional piece of information associated with each of the competitions.

15. The system of claim 14 wherein in each of the competitions one team is a favorite and one team is an underdog, the additional piece of information being a point spread for each competition.

16. The system of claim 15 wherein if the participant selected the favorite for a competition, the processor executing the computer executable code awards points to the participant in the amount of the final score for the favorite minus the point spread for the competition minus the final score for the underdog, and if the participant selected the underdog for the competition, the processor executing the computer executable code awards points to the participant in the amount of the final score for the underdog plus the point spread for the competition minus the final score for the favorite.

17. The system of claim 16 wherein each participant is awarded points for each of the selected predetermined number of teams, the computed score for each participant being the sum of the awarded points for each participant, and a winner is determined from among the plurality of participants based on the participant with the highest computed score.

18. The system of claim 17 wherein the centralized server stores a predetermined number of selected teams for each of the participants at a regular interval and a computed score is derived for each participant based upon the outcomes of competitions held during each regular interval.

19. The system of claim 17 wherein the processor executing the computer executable code prompts a display of the computed scores for each participant to be accessible by each participant at any of the nodes.

20. A method of participating in a game involving a plurality of participants, the method comprising:
viewing a listing of a plurality of competitions between two teams comprising a favorite team and an underdog team, the plurality of competitions to be held during a predetermined time interval;
viewing a point spread for each of the plurality of competitions;
selecting a predetermined number of teams competing in the plurality of competitions;
receiving points, upon the completion of the competitions during the predetermined time interval, for each of the selected predetermined number of teams that is a favorite in the amount of the points scored by the favorite minus the point spread minus the points scored by the underdog;
receiving points, upon the completion of the competitions, for each of the selected predetermined number of teams that is an underdog in the amount of the points scored by the underdog plus the point spread minus the points scored by the favorite;
receiving a total score that is the summation of all of the points received by the participant;
viewing an indication of the winner of the game from among the plurality of participants, the winner being determined based on the highest total score.

21. A method of playing a game having a plurality of participants, the method comprising:
prompting a display of a listing of a plurality of teams competing in scheduled events between at least one team and at least one opposing team along with a point spread for each of the scheduled events;
prompting each participant to select a predetermined number of the teams from the listing of teams competing in the scheduled events;
Receiving a selection of the predetermined number of teams from each participant; and
awarding points to each participant in an amount of the points scored by the selected team in the scheduled event, plus the point spread for the scheduled event, minus the points scored by the opposing team in the scheduled event.

22. A method of playing a game having a plurality of participants, the method comprising:
prompting a display of a listing of a plurality of teams competing in scheduled events between at least one team and at least one opposing team along with a point spread for each team and opposing team with respect to each scheduled event;
prompting each participant to select a predetermined number of the teams for the listing of teams competing in the scheduled events;
receiving a selection of the predetermined number of teams from each participant; and
awarding points to each participant in an amount of the points scored by the selected team in the scheduled event, plus the point spread for the selected team for the scheduled event, minus the points scored by the opposing team in the scheduled event.
